(19) United States
(12) Patent Application Publication
(10) Pub. No.: US 2015/0265089 A1
(43) Pub. Date: Sep. 24, 2015

(54) Surface Unit for Heating

(71) Applicant: Zoppas Industries de Mexico SA de CV, San Luis Potosi (MX)

(72) Inventor: Emilio Palazuelos, San Luis Potosi (MX)

(73) Assignee: ZOPPAS INDUSTRIES DE MEXICO SA DE CV, San Luis Potosi (MX)

(21) Appl. No.: 14/228,777

(22) Filed: Mar. 28, 2014

Related U.S. Application Data
(60) Provisional application No. 61/955,474, filed on Mar. 19, 2014.

(51) Int. Cl. A47J 27/00; H05B 3/03; H05B 1/02

(52) U.S. Cl. CPC A47J 27/004; H05B 1/0261; H05B 3/03

(57) ABSTRACT

An electrical resistance heater is provided with an elongate wire heating element having a geometry with at least three turnarounds that change a direction of travel of the wire heating element. The turnarounds are integral sections of the heating element. Each turnaround couples a first section of a heating element to a second section of the heating element with at least portions of the first and second sections having a same parallel geometry which can include curved sections and linear sections. The wire heating element has a planar top surface and a planar bottom surface and provides uniform heating through the elongate wire heating element. First and second ends of the heating element are configured to be coupled to an electrical power source. At least one insulator can be included.

### CROSS-REFERENCE TO RELATED APPLICATIONS

This application claims the benefit of U.S. 61/955,474, filed Mar. 19, 2014, which application is fully incorporated herein by reference.

### FIELD OF THE INVENTION

The invention relates generally to electric heating units, and more particularly to electric heating units of the type used in range tops, stove tops, grills and the like.

### DESCRIPTION OF RELATED ART

In electrical heating units of the type used in cook tops for ranges, one type of heating element employed is a resistive conductor exposed to air. When an electric current is passed through the conductor, the power dissipated raises the conductor's temperature. Radiant energy is generated which performs the heating function of the element. In some applications, a thin, elongate strip of a metallic ribbon heating material is passed through a machine which corrugates the material. Such a construction is shown, for example, in U.S. Pat. No. 5,393,958. Other patents of interest with respect to ribbon heating elements include U.S. Pat. Nos. 5,453,597, 5,369,874 and 4,161,648. When a current is applied to the ribbon heating element, heat generated by the resulting losses is radiated at a utensil set upon the unit. During a heating cycle, the heating element expands and contracts. If the element is constrained to move, stresses are created in the material; and, stress fractures are the primary cause of heating element failures.

Radiant electric heating units include an electrical heating element such as a coil heating element, or a ribbon heating element. In conventional heating units, the ends of the heating element connect through a thermal switch to an electrical circuit by which current is supplied to the heating element. The unit is installed beneath a heating surface upon which utensils are placed. Heat generated by the heating element is transferred to the heating surface by radiation, and from the heating surface to the utensil by conduction. The thermal switch is responsive to the heating unit temperature exceeding a preset temperature to open the circuit path between a power source and the heating element to cut off current flow to the heating element. When the temperature falls back below the preset temperature, the switch reconnects the circuit path to restore the current flow to the heating element.

Radiant electric heaters are known in which an element of coiled bare electric resistance wire is supported on, and secured by staples to, a layer of microporous thermal and electrical insulating material compacted in a metal support dish. Such heaters are described, for example, in GB-A-1 580 909 and are incorporated in glass-ceramic smooth top cookers.

The term ‘microporous’ is used herein to identify porous or cellular materials in which the ultimate size of the cells or voids is less than the mean free path of an air molecule at NTP, i.e. of the order of 100 nm or smaller. A material which is microporous in this sense will exhibit very low transfer of heat by air conduction (that is collisions between air molecules). Such microporous materials include aerogel, which is a gel in which the liquid phase has been replaced by a gaseous phase in such a way as to avoid the shrinkage which would occur if the gel were dried directly from a liquid. A substantially identical structure can be obtained by controlled precipitation from solution, the temperature and pH being controlled during precipitation to obtain an open lattice precipitate. Other equivalent open lattice structures include pyrogenic (fumed) and electro-thermal types in which a substantial proportion of the particles have an ultimate particle size less than 100 nm. Any of these particulate materials, based for example on silica, alumina or other metal oxides, may be used to prepare a composition which is microporous as defined above.

The microporous insulation typically comprises a dry particulate microporous material as defined hereinabove mixed with ceramic fiber reinforcement, titanium dioxide pacifier and, for high temperature use, a small quantity of alumina powder to resist shrinkage. Such insulation material is described in GB-A-1 580 909.

Radiant electric heaters have also been proposed in which, instead of an element of coiled resistance wire, an element comprising an elongate electrically conductive strip of a metal or metal alloy is provided, the element being supported on edge on an insulating base. Arrangements of this kind are described, for example, in U.S. Pat. Nos. 3,612,829, 3,991,298, 4,161,648 and 4,292,504. In U.S. Pat. No. 600,057, a conductor is mounted on a metal support, or in a groove formed therein, by means of a coating of insulating material such as a vitreous enamel. In U.S. Pat. No. 3,612,829, a convoluted conductive strip element in the form of a spiral is located in recesses pre-formed in the surface of a cast or molded fibrous ceramic refractory material. Staples are used to secure the strip element to the supporting base. In U.S. Pat. No. 3,991,298, the conductive strip element is in the form of a spiral and is loose fitted in a pre-formed spiral groove in a rigid base of fire-resistant mortar.

In U.S. Pat. No. 4,161,648, a convoluted strip element of spiral form is provided with integral downwardly-extending mounting tabs which penetrate an electrically insulating sheet of high-temperature-withstanding board material and in the case of thin material may be bent over at the back of the material. The board-like insulating sheet with the element thereon is then located on top of a layer of microporous thermal insulation material in a supporting dish. In the case of a thick sheet of board material, a hardenable substance is used and is hardened after the tabs have been urged into the material.

In U.S. Pat. No. 4,292,504, a heating element in the form of a thin, foil-like strip of expanded metal is supported on edge substantially along its entire length in a serpentine groove formed in the upper surface of a ceramic fiberboard. The heating element is cemented or held by friction in the groove formed in the board.

Conventional electric stoves are equipped with one or more (usually four) tubular, coil top cooking units housed in a maintop. Some of the units are designed for one wattage rating, and other of the units have a different rating. The units are independent of each other with each unit being a plug-in unit. That is, each unit can be separately removed and replaced without effecting any of the remaining units. The portion of the maintop about each heating unit is typically a raised surface so pots and pans placed on a cooking unit are supported slightly above the range top surface.

Radiant heating elements are also known in the art. Some stoves are equipped with these types of units rather than the tubular coil top units discussed above. Stoves employing radiant heating units are glass top units. That is, the heating units are supported beneath a sheet of glass and heat produced by a unit radiates onto the bottom of the utensil placed on top of the glass. The glass typically 4 mm. thick and the glass top is, for example, a 20″×30″ (51 cm×76 cm) sheet. A cooking utensil placed on the top of the glass (which is generally level with the rest of the range top) is heated by the heat transferred through the glass to the bottom of the utensil.

Radial electric heating elements are also used in grills and hot plates, both in commercial establishments and domestically. Cooking grills used in high volume food outlets generally comprise a top plate on the upper surface of which food is placed to be cooked.

Radial electric heating elements often include a medallion within the central aperture of the element heating surface in order to impart a more finished appearance to the assembly. One embodiment of a medallion is a shallow, inverted sheet-metal cup whose annular wall is of stepped diameter to provide an upwardly facing annular shoulder.

For securing the medallion to the spider, arcuate portions of the latter are lanced out at to provide circumferentially spaced-apart tongues. The lower portion of each tongue provides a radially inwardly projecting ledge upon which the lower margin of the medallion wall rests while the upper portion of each tongue is spaced radially inwardly of its arcuate spider portion to closely receive the medallion wall. With the medallion thus positioned, each tongue may be forced radially outwardly to gripping relation with the medallion to thus retain it assembled with the spider.

Because the spider tongues are rather widely spaced, there is a tendency for the medallion to rock and eventually work itself loose.

In other heating elements, a medallion is provided to interlock with an upper element hub plate so that the medallion remains attached to the heating element subassembly while in operation.

The medallion covers the connection between the vertical connection screw and the heating element.

### SUMMARY OF THE INVENTION

An object of the present invention is to provide an elongated wire heating element for a surface heater that provides uniform heat.

Another object of the present invention is to provide an elongated wire heating element for a surface heater for an appliance that does not use a medallion.

A further object of the present invention is to provide an elongated wire heating element which does not have hot spots.

Yet another object of the present invention is to provide an appliance with an improved elongated wire heating element surface heater.

These and other objects of the present invention are achieved in, an electrical resistance heater. An elongate wire heating element has a geometry with at least three turnarounds that change a direction of travel of the wire heating element. The turnarounds are integral sections of the heating element. Each turnaround couples a first section of a heating element to a second section of the heating element with at least portions of the first and second sections having a same parallel geometry which can include curved sections and linear sections. The wire heating element has a planar top surface and a planar bottom surface and provides uniform heating through the elongate wire heating element. First and second ends of the heating element are configured to be coupled to an electrical power source and are at a different plane that the remaining portion of the elongated wire heating element. At least one insulator can be included.

In another embodiment of the present invention, a heating unit apparatus is adapted to be installed in a cooktop wherein operation of the heating unit is controlled by a controller. An elongate wire heating element has a geometry with at least three turnarounds that change a direction of travel of the wire heating element. The turnarounds are integral sections of the heating element. Each turnaround couples a first section of a heating element to a second section of the heating element with at least portions of the first and second sections having a same parallel geometry which can include curved sections and linear sections. The wire heating element has a planar top surface and a planar bottom surface and provides uniform heating through the elongate wire heating element. First and second ends of the elongated heating element are at a different plane that the remaining portion of the elongated wire heating element. A pan is mounted beneath the cooking surface, and an insulating member fits in the pan and supports the heating element in the pan. The pan and the insulating member form a cavity beneath the cooking surface. A thermal sensor is included for sensing a temperature in the cavity of the heating unit and supplying an indication of the temperature to the controller. The controller is responsive to the temperature indication from the thermal sensor to modulate the amount of power supplied to the heating element during a given interval to maintain the temperature in the cavity substantially at a preselected temperature. The thermal sensor is disposed in a spaced-apart relationship with an underside of the cooking surface. The pan has an opening in a surface thereof and the thermal sensor is inserted through the opening and terminating at a point within the cavity. The thermal sensor is positioned in a temperature sensing relationship to the cavity.

In another embodiment of the present invention, an appliance includes a housing. An elongate wire heating element has a geometry with at least three turnarounds that change a direction of travel of the wire heating element. The turnarounds are integral sections of the heating element. Each turnaround couples a first section of a heating element to a second section of the heating element with at least portions of the first and second sections having a same parallel geometry which can include curved sections and linear sections and a combination thereof. First and second ends of the elongated heating element are at a different plane that the remaining portion of the elongated wire heating element. A pan is sized to fit within an opening of an appliance top in which the heating element is installed.

### BRIEF DESCRIPTION OF THE DRAWINGS

FIGS. 1-4 illustrate various embodiments of electrical resistance heaters with elongated heating elements of the present invention.

FIG. 5 illustrates one embodiment of the present invention with an elongated heating element in an appliance that includes a cooktop.

FIG. 6 illustrates one embodiment of the present invention with an elongated heating element and a pan.

FIG. 7 illustrates one embodiment of the present invention with a controller.

### DETAILED DESCRIPTION

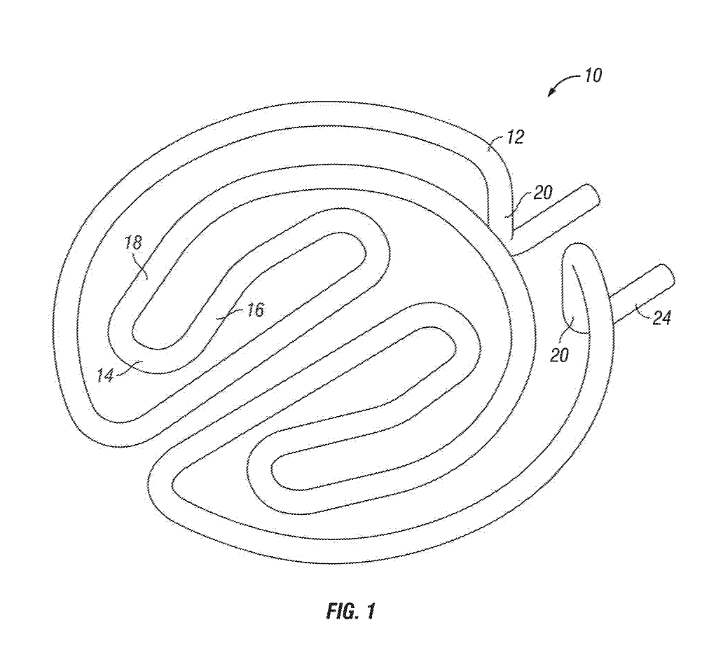

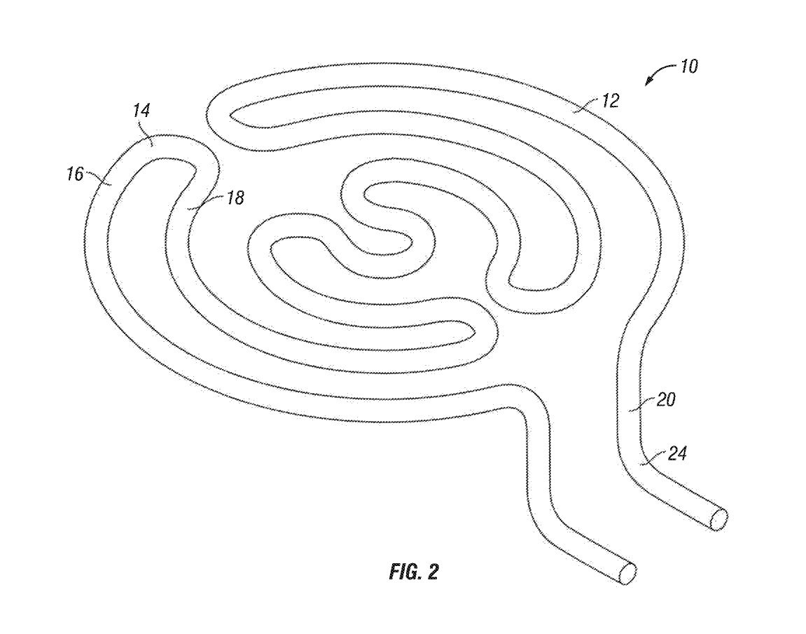

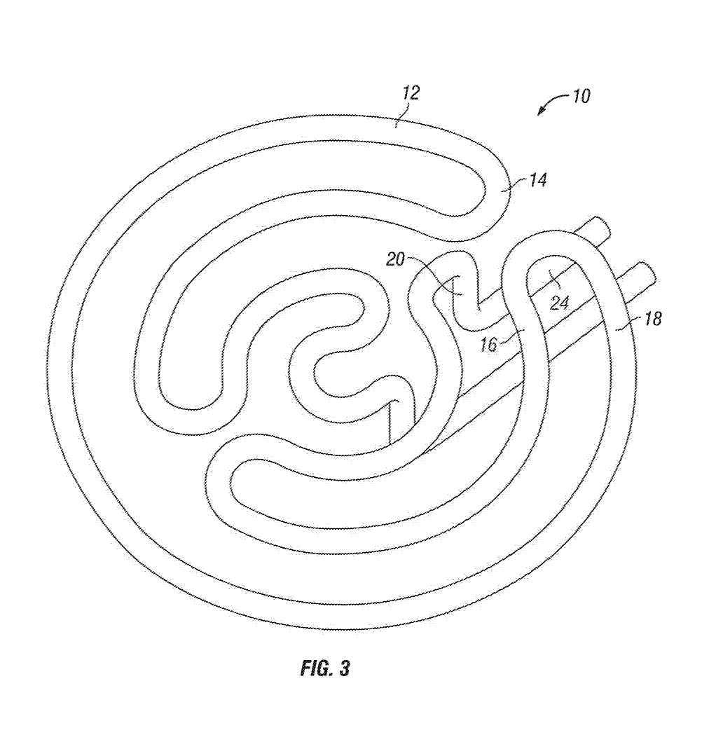

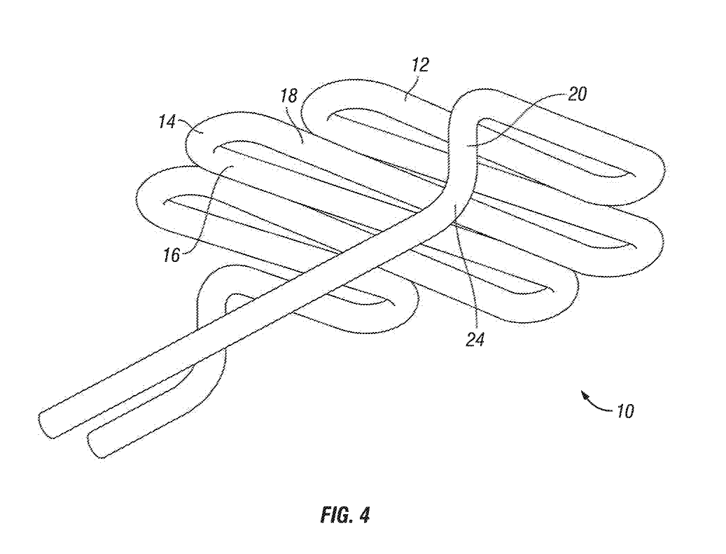

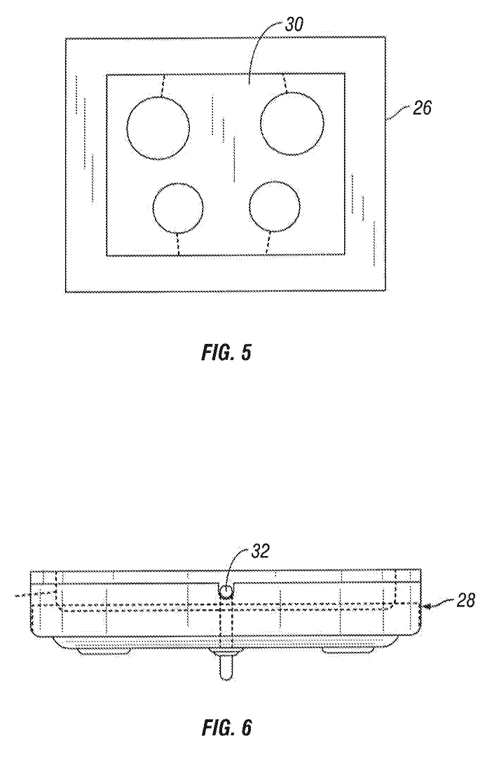

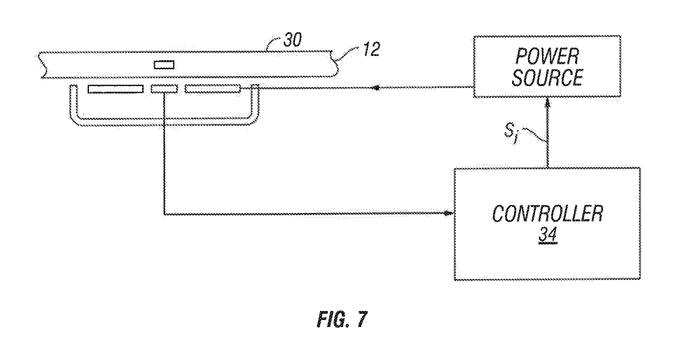

In one embodiment of the present invention, as illustrated in FIGS. 1 and 2, the present invention is an electrical resistance heater 10 with an elongated wire heating element 12. In one embodiment, the electrical resistance heating element 12 has a geometry with at least three turnarounds 14 that change a direction of travel of the wire heating element 12. Each turnaround 14 is an internal section of the elongated wire heating element 12. Each turnaround 14 couples a first section 16 of the elongated wire heating element 12 to a second section 18 of the heating element 12, with at least portions of the first and second sections 16 and 18 having a same parallel geometry which can include curved sections, curvilinear sections, linear sections, and a combination thereof. The elongated wire heating element 12 includes two kick downs 20 which bring the heating element 12 to a different plane for coupled to a source of energy. The kick downs 20 are perpendicular to the upper portion of the electrical resistance heater 10. The kick downs 20 are coupled to bushings, pins and terminals 24 that are parallel to the upper portion of the elongated wire heating element 12. A medallion is eliminated and the elongated wire heating element 12 extends into an area where the medallion would normally be.

The wire heating element 12 has a planar top surface and a planar bottom surface. In one embodiment, the planar top and bottom surfaces are mirror images of each other. The wire heating element 12 provides uniform heating through the elongate wire heating element 12.

First and second ends 16 and 18 of the heating element 12 are configured to be coupled to an electrical power source and are at a different plane that the other portions of the elongated wire heating element 12. The heating element 12 includes at least one insulator 24. In one embodiment, the heating element 12 is configured to be in an appliance 26. Examples of appliances 26 include but are not limited to, stoves, grills, and any other appliance that uses a surface heater element.

In one embodiment, the present invention is an appliance 26 with the heating element 12. A pan 28 can be provided and sized to fit within an opening of an appliance top in which the heating element 12 is installed.

In another embodiment of the present invention, a heating unit apparatus 12 is adapted to be installed in a cooktop 30 wherein operation of the heating unit is controlled by a controller. An elongate wire heating element 12 has a geometry with at least three turnarounds 14 that change a direction of travel of the wire heating element 12. The turnarounds 14 are integral sections of the heating element 12. Each turnaround 14 couples a first section 16 of a heating element 12 to a second section 18 of the heating element 12 with at least portions of the first and second sections 16 and 18 having a same parallel geometry which can include curved sections and linear sections. The wire heating element 12 has a planar top surface and a planar bottom surface and provides uniform heating through the elongate wire heating element 12. First and second ends of the heating element 12 configured to be coupled to an electrical power source and are at a different plane that the other portions of the elongated wire heating element 12. A pan 28 is mounted beneath the cooking surface, and an insulating member 24 fits in the pan 28 and supports the heating element 12 in the pan 28. The pan 28 and the insulating member form a cavity beneath the cooking surface. A thermal sensor 32 is included for sensing a temperature in the cavity of the heating unit and supplying an indication of the temperature to the controller 34. The controller 34 is responsive to the temperature indication from the thermal sensor 32 to modulate the amount of power supplied to the heating element 12 during a given interval to maintain the temperature in the cavity substantially at a preselected temperature. The thermal sensor 32 is disposed in a spaced-apart relationship with an underside of the cooking surface. The pan 28 has an opening in a surface thereof and the thermal sensor 32 is inserted through the opening and terminating at a point within the cavity. The thermal sensor 32 is positioned in a temperature sensing relationship to the cavity.

In another embodiment of the present invention, an appliance includes a housing. An elongate wire heating element 12 has a geometry with at least three turnarounds 14 that change a direction of travel of the wire heating element 12. The turnarounds 14 are integral sections of the heating element 12. Each turnaround 14 couples a first section 16 of a heating element 12 to a second section 18 of the heating element 12 with at least portions of the first and second sections 16 and 18 having a same parallel geometry which can include curved sections and linear sections and a combination thereof. First and second ends of the heating element 12 configured to be coupled to an electrical power source and are at a different plane that the other portions of the elongated wire heating element 12. A pan 28 is sized to fit within an opening of an appliance top in which the heating element 12 is installed.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Particularly, while the concept “component” is used in the embodiments of the systems and methods described above, it will be evident that such concept can be interchangeably used with equivalent concepts such as, class, method, type, interface, module, object model, and other suitable concepts. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed is:

1. An electrical resistance heater, comprising:
an elongated wire heating element having a geometry with at least three turnarounds that change a direction of travel of the wire heating element, the turnarounds being integral sections of the heating element, each of a turnaround coupling a first section of a heating element to a second section of the heating element with at least portions of the first and second sections having a same parallel geometry which can include curved sections and linear sections, the wire heating element having a planar top surface and a planar bottom surface and providing uniform heating through the elongate wire heating element;
first and second ends of the heating element configured to be coupled to an electrical power source and are at a different plane that the other portions of the elongated wire heating element; and
at least one insulator.

2. The heater of claim 1, wherein at least one of the turnarounds changes a travel of direction in an amount of 180 degrees of a first section to a second section.

3. The heater of claim 1, wherein at least two of the turnarounds changes a travel of direction in an amount of 180 degrees of a first section to a second section.

4. The heater of claim 1, wherein the geometry eliminates hot spots.

5. The heater of claim 4, wherein the geometry provides for an even spacing of the sections of the heating wire element.

6. The heating element of claim 1, wherein the heating element is configured to be in an appliance.

7. The heating element of claim 4, further comprising:
a pan sized to fit within an opening of an appliance top in which heating element is installed.

8. The heating element of claim 5, wherein the pan provides support for at least a portion of the heating element.

9. The heating element of claim 1, further comprising:
an electrical connector coupled to the heating element and adapted to connect with an electrical connector installed in an appliance top, and used to supply electrical current to the heating element.

10. The element of claim 1, wherein the appliance is selected from at least one of, a stove, grill and an appliance with a surface heating element.

11. The element of claim 4, wherein the appliance includes a glass top.

12. The element of claim 1, further comprising:
a thermal sensor for sensing a temperature in the proximity of the heating element and supplying an indication of the temperature to the controller, the controller being responsive to the temperature indication from the thermal sensor to modulate the amount of power supplied to the heating element during a given interval to maintain the temperature in the cavity substantially at a preselected temperature.

13. The element of claim 4, further comprising:
a thermal sensor positioned in a temperature sensing relationship to the heating element.

14. The heating unit of claim 5, wherein the heating element is a composition heating element.

15. The heating unit of claim 4, wherein the pan includes a bottom surface for the thermal sensor to be inserted in the heating unit through the bottom of the pan.

16. The heating unit of claim 4, wherein the pan has an opening in a sidewall thereof and the thermal sensor extends through the opening into the pan.

17. The heating unit of claim 4, wherein the insulator is a cake of material fitted in the pan and an opening is the sidewall is positioned above an upper surface of the insulating member.

18. The heating unit of claim 17, wherein the thermal sensor extends above the heating element parallel to the plan of the heating element.

19. The heating unit of claim 1, wherein the heating element is a coil heating element.

20. The heating unit of claim 1, wherein the heating element is a ribbon heating element.

21. The heating unit of claim 1, wherein the heating element is an etched heating element.

22. The heating unit of claim 1, wherein the heating element is a cut foil heating element.

23. The heating unit of claim 22, wherein the heating element is a laser cut heating element.

24. The heating unit of claim 1, wherein the thermal sensor includes a PRT sensing element.

25. The heating unit of claim 1, wherein the thermal sensor is a RTD sensing element.

26. The heating unit of claim 1, wherein the thermal sensor is a thermocouple.

27. A heating unit apparatus adapted to be installed in a cooktop wherein operation of the heating unit is controlled by a controller, the heating unit comprising:
an elongate wire heating element having a geometry with at least three turnarounds that change a direction of travel of the wire heating element, the turnarounds being integral sections of the heating element, each of a turnaround coupling a first section of a heating element to a second section of the heating element with at least portions of the first and second sections having a same parallel geometry which can include curved sections and linear sections, the wire heating element having a planar top surface and a planar bottom surface and providing uniform heating through the elongate wire heating element, first and second ends of the heating element configured to be coupled to an electrical power source and are at a different plane that the other portions of the elongated wire heating element;
a pan mounted beneath the cooking surface, and an insulating member fitting in the pan and supporting the heating element in the pan, the pan and the insulating member forming a cavity beneath the cooking surface; and
a thermal sensor for sensing a temperature in the cavity of the heating unit and supplying an indication of the temperature to the controller, the controller being responsive to the temperature indication from the thermal sensor to modulate the amount of power supplied to the heating element during a given interval to maintain the temperature in the cavity substantially at a preselected temperature;
wherein the thermal sensor is disposed in a spaced-apart relationship with an underside of the cooking surface,
wherein the pan has an opening in a surface thereof and the thermal sensor is inserted through the opening and terminating at a point within the cavity, the thermal sensor being positioned in a temperature sensing relationship to the cavity.

28. The heating unit of claim 27, wherein the heating element is a composition heating element.

29. The heating unit of claim 27, wherein the thermal sensor includes a PRT sensing element.

30. The heating unit of claim 27, wherein the thermal sensor is a RID sensing element.

31. The heating unit of claim 27, wherein the thermal sensor is a thermocouple.

32. An appliance, comprising:
a housing;
an elongate wire heating element that has a geometry with at least three turnarounds which change a direction of travel of the wire heating element, each of a turnaround being an internal section of the elongated wire heating element, each of a turnaround coupling a first section of a heating element of the elongate wire heating element to a second section of the heating element, with at least portions of the first and second sections having a same parallel geometry which can include curved sections, curvilinear sections, linear sections, and a combination thereof, first and second ends of the heating element configured to be coupled to an electrical power source and are at a different plane that the other portions of the elongated wire heating element;
a pan sized to fit within an opening of an appliance top in which the heating element is installed.

33. The appliance of claim 32, wherein the pan provides support for at least a portion of the heating element.

34. The appliance of claim 32, further comprising:
an electrical connector coupled to the heating element and adapted to connect with an electrical connector installed in an appliance top, and used to supply electrical current to the heating element.

35. The appliance of claim 32, wherein the appliance is selected from at least one of, a stove, grill and an appliance with a surface heater.

36. The appliance of claim 32, wherein the appliance includes a glass top.

37. The appliance of claim 32, further comprising:
a thermal sensor for sensing a temperature in the proximity of the heating element and supplying an indication of the temperature to a controller, the controller being responsive to the temperature indication from the thermal sensor to modulate the amount of power supplied to the heating element during a given interval to maintain the temperature in the cavity substantially at a preselected temperature

38. The appliance of claim 32, further comprising:
a thermal sensor positioned in a temperature sensing relationship to the heating element.

39. The appliance of claim 32, wherein the heating element is a composition heating element.

40. The appliance of claim 32, wherein the pan includes a bottom surface for the thermal sensor to be inserted in the heating unit through the bottom of the pan.

41. The appliance of claim 32, wherein the pan has an opening in a sidewall thereof and the thermal sensor extends through the opening into the pan.

42. The appliance of claim 32, wherein the insulator is a cake of material fitted in the pan and an opening is the sidewall is positioned above an upper surface of the insulating member.

43. The appliance of claim 42, wherein the thermal sensor extends above the heating element parallel to the plan of the heating element.

44. The appliance of claim 37, wherein the heating element is a coil heating element.

45. The appliance of claim 37, wherein the heating element is a ribbon heating element.

46. The appliance of claim 37, wherein the heating element is an etched heating element.

47. The appliance of claim 37, wherein the heating element is a cut foil heating element.

48. The appliance of claim 47, wherein the heating element is a laser cut heating element.

49. The appliance of claim 37, wherein the thermal sensor includes a PRT sensing element.

50. The appliance of claim 37, wherein the thermal sensor is a RTD sensing element.

51. The appliance of claim 37, wherein the thermal sensor is a thermocouple.
